(19) United States
(12) Patent Application Publication
(10) Pub. No.: US 2005/0088460 A1
(43) Pub. Date: Apr. 28, 2005

(54) Association of image data with information that relates to variation at the time of photograhy, and utilization of the information associated with the image data

(76) Inventors: Makoto Ouchi, Nagano-ken (JP); Naoki Kuwata, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/933,198

(22) Filed: Sep. 1, 2004

(30) Foreign Application Priority Data
Sep. 2, 2003 (JP) 2003-309844
Jul. 13, 2004 (JP) 2004-205397

(51) Int. Cl. G09G 5/00

(52) U.S. Cl. 345/672

(57) ABSTRACT

To provide a technique capable of utilizing information afterward, which relates to variation at the time image data is acquired, such as blurring. An image data generation method for generating image data in an image generation device that is capable of photographing a target object, comprises: (a) acquiring the image data by photographing the target object; (b) acquiring variation-related information, which relates to a spatial variation of the image generation device at the time the image data is acquired; and (c) associating and storing the acquired image data and the acquired variation-related information with one another.

### CROSS REFERENCE

The present application is based on, and claims priority from, Japanese Applications No.2003-309844 filed Sep. 2, 2003 and No. 2004-205397 filed Jul. 13, 2004, the disclosures of which are herein incorporated by reference.

### BACKGROUND OF THE INVENTION

1. Field of the Invention

The present invention relates to a technique of utilizing additional information associated with image data.

2. Description of the Related Art

When photographing a target object with a digital still camera, there may be blurring in a photographed image due to hand movement. A user of the camera, therefore, needs to classify the image according to a degree of blurring.

Examples of conventional techniques of preventing blurring of image due to hand movement include those disclosed in Japanese Patent Gazette No. 3,333,015 and Japanese Patent Gazette No. 3,380,402. Photography is prohibited in case of hand movement in the technique disclosed in the Japanese Patent Gazette No. 3,333,015; whereas an optical mechanism is employed to prevent blurring in the technique disclosed in the Japanese Patent Gazette No. 3,380,402.

On the other hand, a digital still camera is typically equipped with a crystal liquid display module for displaying a preview image. The liquid crystal display module, however, is typically of low resolution and has difficulty in recognizing a degree of blurring.

The above-mentioned problem is also common with digital video cameras for photographing dynamic images.

### SUMMARY OF THE INVENTION

The purpose of the present invention is to solve the above-mentioned problem accompanying the conventional techniques and to provide a technique capable of utilizing information afterward, which relates to variation at the time image data is acquired, such as blurring.

At least part of the above and the other related objects is attained by a first method of the present invention. The first method is an image data generation method for generating image data in an image generation device that is capable of photographing a target object. The method comprises the steps of: (a) acquiring the image data by photographing the target object; (b) acquiring variation-related information, wherein the variation-related information relates to a spatial variation of the image generation device at the time the image data is acquired; and (c) associating and storing the acquired image data and the acquired variation-related information with one another.

The first method associates the image data with the variation-related information and stores them together. This allows for utilization of the variation-related information afterward.

A second method of the present invention is a control method for controlling an output module that outputs a target image represented by image data, by using the image data acquired by an image generation module and additional information associated with the image data. The method comprises the steps of: (a) reading out the image data and the additional information; (b) generating output data by using the image data, where the output data is to be supplied to the output module and represents the target image; and (c) executing a predetermined control with respect to output of the target image from the output module, according to variation-related information that is included in the additional information and relates to a spatial variation of the image generation module at the time the image data is acquired.

The second method executes a predetermined control with respect to output of the target image from the output module according to variation-related information. This allows for the change of output from the output module according to the variation-related information.

It should be noted that the present invention may be actualized by a diversity of applications such as a method and a device for image data generation, a method and a device for image output, a method and a device for output device control, a method and a device for image data processing, computer programs that attain these methods or functions of these devices, recording media in which such computer programs are recorded, and data signals that include such computer programs and are embodied in carrier waves.

### BRIEF DESCRIPTION OF THE DRAWINGS

FIG. 1 is a schematic that shows an image processing system of a first embodiment;

FIG. 2 is a schematic that shows a general arrangement of a digital still camera 100;

FIG. 3 is a schematic that shows in diagram a structure of an image file generated in the digital still camera 100;

FIG. 4 is a flowchart that shows details of processing for generating an image file in the digital still camera 100;

FIG. 5 is a flowchart that shows details of processing for reproducing an image in the digital still camera 100;

FIGS. 6(A) and 6(B) are schematics that show a method for generating a blurring indicator;

FIGS. 7(A) through 7(C) are schematics that show preview images displayed on a display module 150 of the digital still camera 100;

FIGS. 8(A) through 8(C) are schematics that show message images displayed on the display module 150 of the digital still camera 100 immediately after photography;

FIG. 9 is a flowchart that shows details of processing for modifying a photography condition for the next photography in the digital still camera 100;

FIG. 10 is a schematic that shows a general arrangement of a printer 200;

FIG. 11 is a flowchart that shows details of processing for printing an image in the printer 200;

FIG. 12 is a schematic that shows an image processing system of a second embodiment;

FIG. 13 is a schematic that shows a general arrangement of a digital video camera 100B;

FIG. 14 is a flowchart that shows details of processing for generating image indicative information in the digital video camera 100B;

FIGS. 15(A) through 15(C) are schematics of images displayed on the display module 150B of the digital video camera 100B;

FIG. 16 is a schematic that shows details of the image indicative information;

FIG. 17 is a schematic that shows a general arrangement of a personal computer 400;

FIG. 18 is a flowchart that shows details of processing for displaying a dynamic image in the computer 400; and

FIG. 19 is a schematic that shows an image displayed on a display module 430.

### DESCRIPTION OF THE PREFERRED EMBODIMENT

Embodiments of the present invention are discussed below based on examples in the following order.

A. First Embodiment:

A1. Arrangement of Image Processing System:

A2. Arrangement of Digital Still Camera:

A2-1. Generation of Image File Including Blurring Information in Digital Still Camera:

A2-2. Display of Image with Use of Blurring Information in Digital Still Camera:

A2-3. Adjustment of Photography Condition with Use of Blurring Information in Digital Still Camera:

A3. Arrangement of Printer:

A3-1. Printing with Use of Blurring Information in Printer:

A4. Modification of First Embodiment:

B. Second Embodiment:

B1. Arrangement of Image Processing System:

B2. Arrangement of Digital Video Camera:

B2-1. Generation of Image Indicative Information in Digital Video Camera:

B3. Arrangement of Computer:

B3-1. Display of Image with Use of Image Indicative Information in Computer:

B4. Modifications of Second Embodiment:

A. First Embodiment:

A1. Arrangement of Image Processing System:

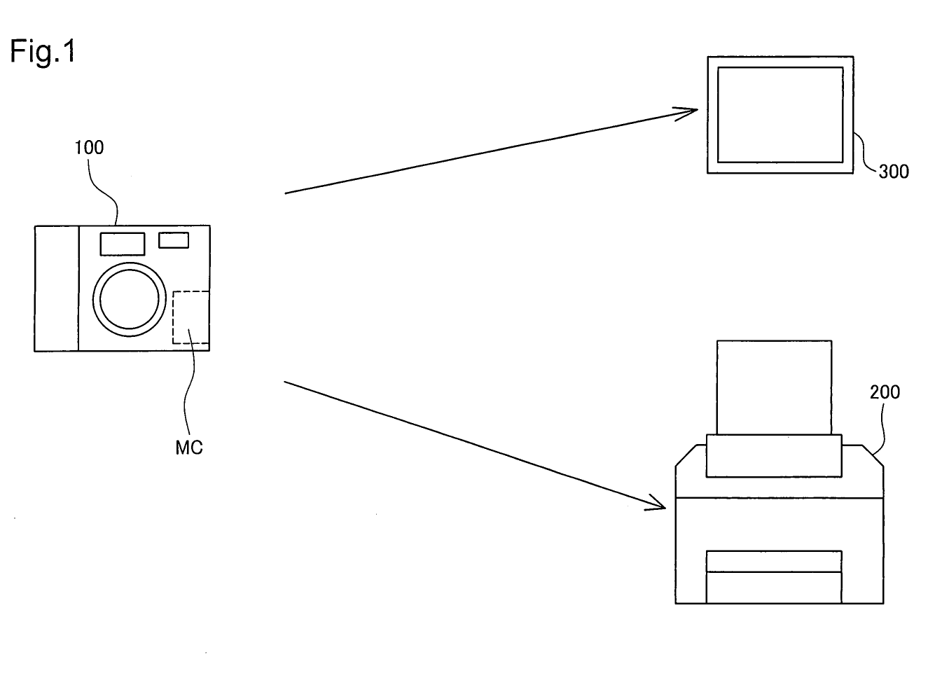

FIG. 1 is a schematic that shows an image processing system of a first embodiment. The image processing system comprises a digital still camera 100 and a printer 200. The digital still camera 100 photographs a target object and generates image data. The image represented by the image data is printed by the printer 200. The image represented by the image data is also displayed on a display module provided in the digital still camera 100 or on a display device 300 such as a monitor or a projector provided external to the camera. The image data is provided from the digital still camera 100 to the printer 200 or to the display device 300 external to the camera via a cable or via a memory card MC.

A2. Arrangement of Digital Still Camera:

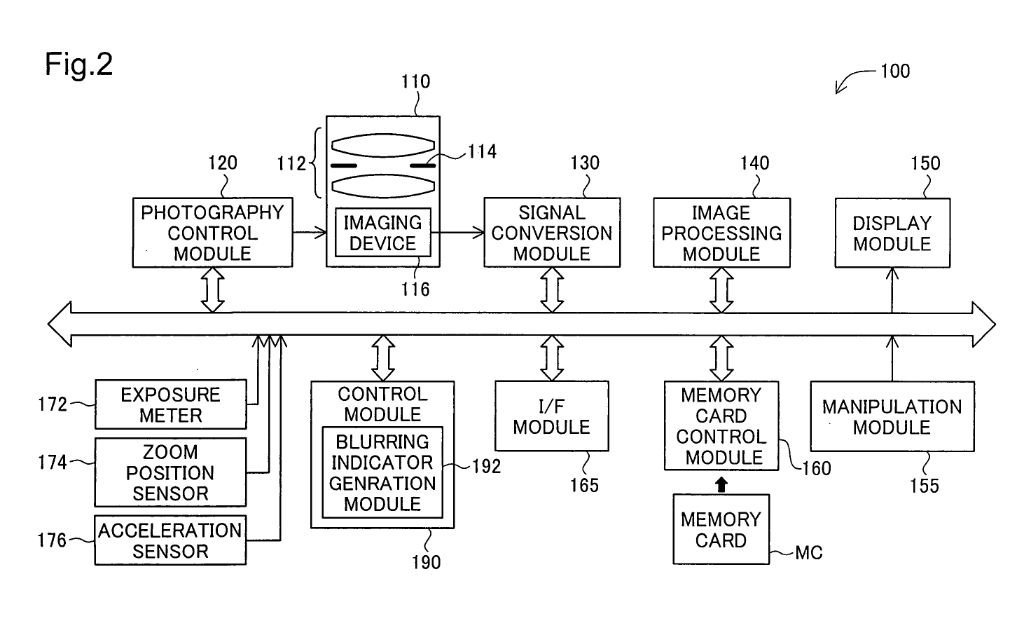

FIG. 2 is a schematic that shows a general arrangement of the digital still camera 100. The digital still camera 100 comprises a photography module 110, a photography control module 120, a signal conversion module 130, an image processing module 140, a display module 150, a manipulation module 155, a memory card control module 160, an interface module (I/F module) 165, a group of sensors 172, 174, 176, and a control module 190 for controlling operations of the respective modules. It should be noted that in this embodiment, functions of the image processing module 140 and the control module 190 are implemented by computer programs.

The photography module 110 includes a lens system 112, an aperture 114, and an imaging device 116. A CCD image sensor is employed as the imaging device 116 in this embodiment. The photography module 110 is typically provided with a mechanical shutter (not shown) in order to prevent noises. In this case, however, the imaging device 116 functions as the electronic shutter. The photography control module 120 controls the photography module 110 and regulates photography of a target object by means of the photography module 110. The signal conversion module 130 converts analog image signals output from the imaging device 116 into digital image signals. The image processing module 140 uses the converted digital image signals so as to generate image data for storage. Specifically, the image processing module 140 converts RGB data into YCbCr data, compresses the converted data, and thereby generates image data for storage. The image data is stored in the memory card MC attached to a memory card slot (not shown).

The display module 150 displays an image represented by the stored image data, an image photographed by the photography module 110, a menu image for setting up photography conditions, or the like.

The manipulation module 155 can execute various processing according to instructions from a user. For example, the user can cause the display module 150 to display the above-mentioned menu image by manipulating the manipulation module 155. The user can also set up a photography condition by manipulating the manipulation module 155. The photography control module 120 causes the photography module 110 to execute photography according to the photography condition set up as above. At the execution of photography, the photography control module 120 uses a result of detection from an exposure meter 172 so as to control operations of the aperture 114 and the imaging device 116, and thereby adjusts an aperture value and a shutter speed.

The control module 190 controls the memory card control module 160 to store image data into the memory card MC. At the storage of image data, the control module 190 acquires additional information including photography information and attaches the additional information to the image data. As a result, the image data and the additional information are associated with one another, and an image file that includes both the image data and the additional information is generated. The memory card control module 160 then stores the generated image file into the memory card MC. The stored image file is available to an external output device via the memory card MC or via the I/F module 165 and the cable.

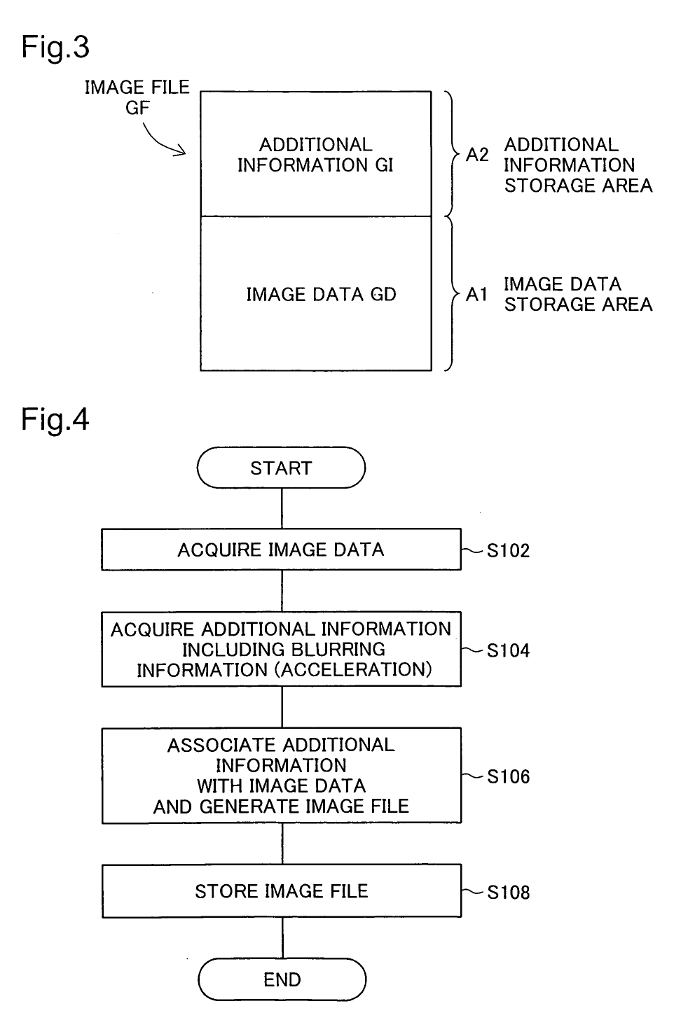

FIG. 3 is a schematic that shows in diagram a structure of an image file generated in the digital still camera 100. In this embodiment, an image file GF is stored in an Exif format. An Exif file has a structure that meets image file format standards (Exif) for digital still cameras and has a specification that is defined by Japan Electronics and Information Technology Industries Association (JEITA). As shown, the Exif file has an image data storage area A1 for storing image data GD and an additional information storage area A2 for storing additional information GI. The image data GD is stored in a JPEG format; whereas the additional information GI is stored in a TIFF format (that is, a format in which data and its data area are specified by tags).

The additional information storage area A2 stores photography information at the time the image data is acquired, a parameter indicating an image processing condition for an output device, a thumbnail image, and the like. Examples of the photography information include datetime of photography, shutter speed, focal length, aperture value, photography scene, and the like. Examples of the parameter indicating the image processing condition include parameters for image quality adjustment such as contrast or brightness corresponding to the photography scene.

In this embodiment, the additional information includes a focal length of the lens system 112 detected by a zoom position sensor 174 (FIG. 2), photography information such as a shutter speed (that is, charge storage period) of the imaging device 116, or the like. In this embodiment, the additional information includes an acceleration detected by an acceleration sensor 176.

As described previously, there may be blurring in an acquired image due to hand movement at the time a target object is photographed by the digital still camera 100. Although the image can be displayed on the display module 150, the display module 150, however, is typically of low resolution and has difficulty in recognizing blurring that is generated in the image due to hand movement. Therefore, in this embodiment, the acceleration sensor 176 is provided and the acceleration is included in the additional information.

The acceleration sensor 176 can detect a spatial variation (blurring) of the digital still camera 100 at the time of photography. That is to say, the acceleration sensor 176 detects a move of the camera 100 along two axes, more specifically, a move of the camera 100 along directions (x-direction and y-direction) that are parallel to a row and a column of a pixel array arranged as a matrix.

The camera 100 functions as an image generation device and as an image output device. In case where the camera 100 functions as an image generation device, the photography module 110, the photography control module 120, the signal conversion module 130, and the image processing module 140 are equivalent to image data acquisition module of the present invention; whereas the acceleration sensor 176 and the control module 190 are equivalent to variation-related information acquisition module. Additionally, the memory card control module 160 and the control module 190 are equivalent to storage execution module. Furthermore, the image processing module 140, the control module 190, and the display module 150 are equivalent to notification module. On the other hand, in case where the camera 100 functions as an image output device, the memory card control module 160 and the control module 190 are equivalent to readout module; whereas the image processing module 140 and the control module 190 are equivalent to output data generation module. Additionally, the display module 150 is equivalent to an output module. In particular, the memory card control module 160, the image processing module 140, and the control module 190 function as control device for controlling the display module 150.

A2-1. Generation of Image File Including Blurring Information in Digital Still Camera:

FIG. 4 is a flowchart that shows details of processing for generating an image file in the digital still camera 100.

In step S102, image data is acquired through photography. Specifically, the photography control module 120 locates the lens system 112 at a zoom location, which is a location selected through manipulation of the manipulation module 155 by a user. The photography control module 120 then uses a result of detection from the exposure meter 172 and thereby sets up a degree of opening of the aperture 114 and a shutter speed of the imaging device 116. Then a target object is photographed according to the set up photography conditions and thereby image data is acquired.

In step S104, additional information including blurring information is acquired. Specifically, the control module 190 acquires an acceleration given from the acceleration sensor 176 as blurring information (physical information) that relates to blurring of the camera 100 at the time the user pressed a shutter button. The control module 190 acquires the shutter speed that was used in the photography control module 120. The control module 190 further acquires a focal length of the lens system 112 that is based on a result of detection by the zoom position sensor 174.

In step S106, the image data acquired in the step S102 and the additional information acquired in the step S104 are associated with one another and an image file is generated.

In step S108, the control module 190 controls the memory card control module 160 to store the image file into a memory card MC.

As described above, association and storage of the image data and the additional information allows for use of the blurring information after the photography, which is included in the additional information, for various processing carried out either internal or external to the digital still camera, as will be described below. That is to say, the image data and the additional information are stored in a way available to external devices after the photography.

A2-2. Display of Image with Use of Blurring Information in Digital Still Camera:

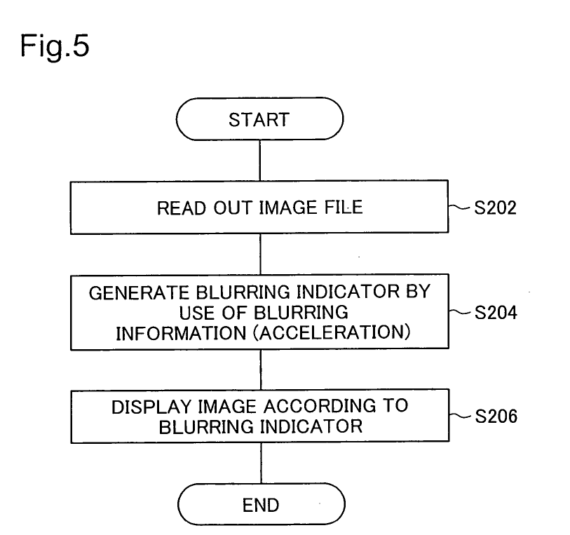

FIG. 5 is a flowchart that shows details of processing for reproducing an image in the digital still camera 100.

In step S202, the image file stored in the memory card MC is read out. Specifically, the user manipulates the manipulation module 155 to select the image file and to cause the display module 150 to display a preview image. At this time, the control module 190 causes the memory card control module 160 to read out the image file stored in the memory card MC.

In step 204, a blurring indicator is generated using the blurring information included in the image file. Specifically, the control module 190 analyzes the additional information included in the image file and uses the acceleration as the blurring information included in the additional information, the shutter speed, and the focal length so as to generate a blurring indicator that indicates a degree of blurring. It should be noted that the blurring indicator is generated by a blurring indicator generation module 192 (FIG. 2).

The blurring of image due to camera movement at the time of photography is generated during an open period of shutter, that is to say, during a charge storage period of imaging device, by a beam of light emitted from one point on the target object entering two or more pixels in the imaging device 116. In this embodiment, accordingly, the blurring indicator is generated by paying attention to the number of pixels on which the light from one point on the target object enters.

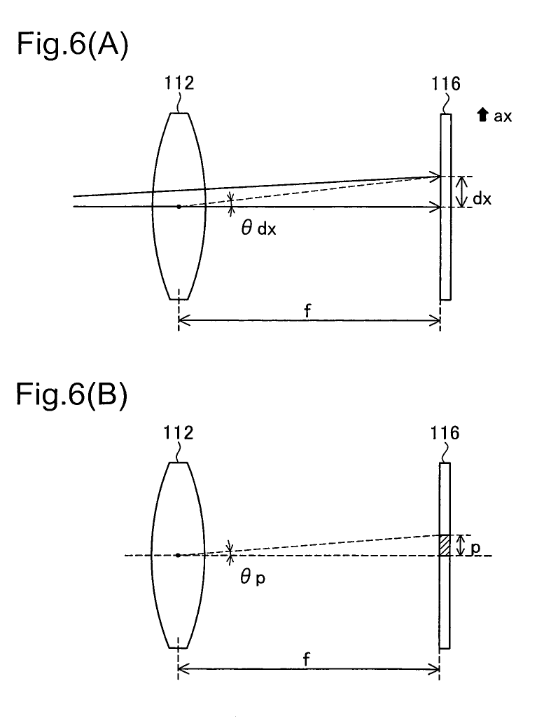

FIGS. 6(A) and 6(B) are schematics that show a method for generating a blurring indicator. FIG. 6(A) shows a displacement of light incident angle that may be generated during an open period of shutter, i.e. a blurring angle θdx. FIG. 6(B) shows a displacement of light incident angle that corresponds to one pixel in the imaging device 116, i.e., a reference angle θp. Although only the blurring angle θdx in x-direction is shown in FIG. 6(A) for convenience of drawing, the same is true for a blurring angle θdy in y-direction.

Suppose the lens system 112 has an actual focal length of f, and an incident light has displacements of dx, dy in the x-direction and the y-direction in the imaging device 116, the blurring angles θdx, θdy can be expressed by the following equation (1):
θdx=arctan(dx/f)
θdy=arctan(dy/f) (1).

Suppose the camera 100 has accelerations of ax, ay in the x-direction and the y-direction and a shutter speed (charge storage period) of st, the displacements dx, dy can be expressed by the following equation (2).
dx=(ax*st²)/2
dy=(ay*st²)/2 (2).

As will be appreciated from the equations (1), (2), the blurring angles θdx, θdy are calculated through use of the accelerations ax, ay, the shutter speed st, and the focal length f.

One the other hand, as shown in FIG. 6(B), suppose the pixels have a pixel-to-pixel pitch of p, the reference angle θp corresponding to one pixel can be expressed by the following equation:
θp=arctan(p/f)

It should be noted that the blurring angles θdx, θdy and the reference angle θp can also be calculated through use of 35 mm equivalent focal length fc, instead of the actual focal length f of the lens system 112. In this case, a value of fc*w/35 (=f) may be used instead of f. The value w (mm) is a width of light-receptive area in the imaging device 116.

In step S204, the blurring indicator is generated based on a relationship between the values θdx, θdy and θp.

Specifically, if a condition of “θdx<=θp and θdy <=θp (that is, θdx and θdy are not greater than θp)” is satisfied, the light emitted from one point on the target object is determined to be entering only one pixel in the imaging device 116. In such a case, a first blurring indicator is generated, which indicates that almost no blurring has occurred at the time of photography, that is to say, almost no blurring exists in the image.

On the other hand, if a condition of “θdx>θp or θdy>θp” is satisfied, the light emitted from one point on the target object is determined to be entering two or more pixels in the imaging device 116. In particular, if a condition of “θp<Max (θdx, θdy)<2*θp” is satisfied (that is, if the greater one of θdx and θdy is more than θp and less than 2*θp), the light emitted from one point on the target object is determined to be entering two pixels in the imaging device 116. In such a case, a second blurring indicator is generated, which indicates that a relatively small amount of blurring has occurred at the time of photography, that is to say, a relatively small amount of blurring exists in the image. On the other hand, if the condition of “θp<Max (θdx, θdy)<2*θp” is not satisfied, the light emitted from one point on the target object is determined to be entering three or more pixels in the imaging device 116. In such a case, a third blurring indicator is generated, which indicates that a relatively large amount of blurring has occurred at the time of photography, that is to say, a relatively large amount of blurring exists in the image.

In step S206, an image is displayed according to the blurring indicator generated in step S204. Specifically, the control module 190 causes the image processing module 140 to display a preview image by using the image data included within the image file. Additionally, the control module 190 also causes the image processing module 140 to display a frame image at the periphery of the preview image according to the blurring indicator generated by the blurring indicator generation module 192.

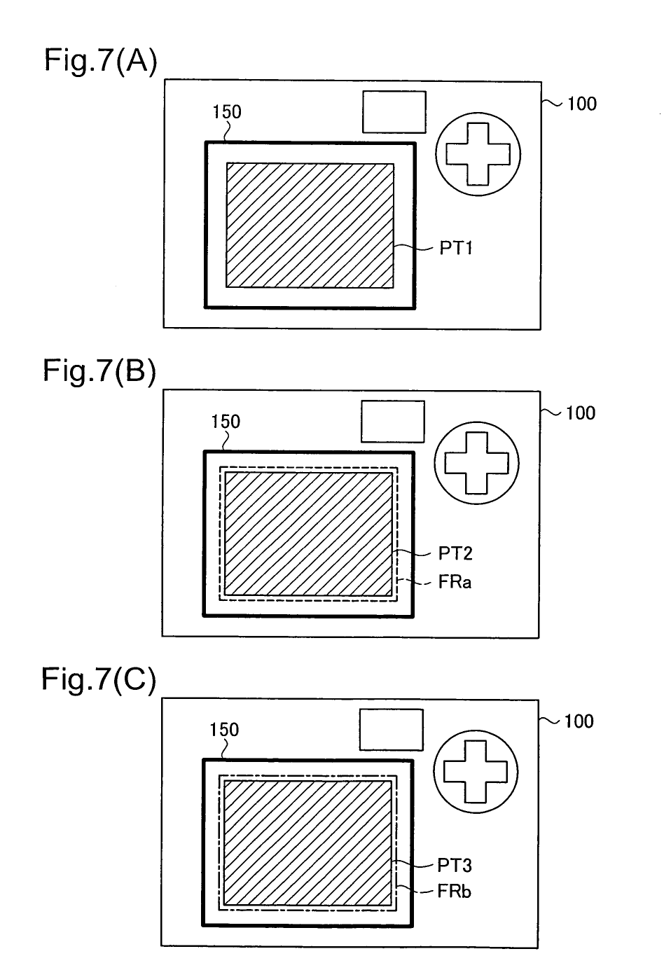

FIGS. 7(A) through 7(C) are schematics that show preview images displayed on the display module 150 of the digital still camera 100.

FIG. 7(A) shows an image that is to be displayed if the first blurring indicator, which indicates that almost no blurring has occurred at the time of photography, is generated. As shown, the display module 150 displays a first preview image PT1 with no frame image at the periphery thereof.

FIG. 7(B) shows an image that is displayed if the second blurring indicator, which indicates that a small amount of blurring has occurred at the time of photography, is generated. As shown, the display module 150 displays a second preview image PT2 with a yellow frame image FRa at the periphery thereof.

FIG. 7(C) shows an image that is displayed if the third blurring indicator, which indicates that a large amount of blurring has occurred at the time of photography, is generated. As shown, the display module 150 displays a third preview image PT3 with a red frame image FRb at the periphery thereof.

By switching between display and not-display of frame image and changing color of frame image to be displayed according to the blurring indicator as described above, the user can make various countermeasures. For example, if it is determined that a large amount of blurring has occurred at the time of photography, that is to say, if it is presumed that a large amount of blurring exists in the image, the user can delete the target image or take another photograph again.

In this embodiment, no frame image is displayed at the periphery of the preview image if the first blurring indicator is generated, but instead of this, a blue frame image, for example, may be displayed. Additionally, in this embodiment, the color of frame image is changed to represent various degrees of blurring at the time of photography, but instead of this, the line style of frame image may be changed to represent the same. Furthermore, in this embodiment, the frame image at the periphery of the preview image is used to represent the degree of blurring at the time of photography, but instead of this, other pattern image may be used to represent the same.

Additionally, although the display module 150 displays one preview image corresponding to one image file sequentially in this embodiment, the display module 150 may alternatively display a plurality of preview images corresponding to a plurality of image files (e.g. four files) at one time. In such a case, each preview image may have a frame image that meets the corresponding type of blurring indicator.

In this embodiment, the user causes the display module 150 to display each preview image with a frame image that meets the corresponding type of blurring indicator, as shown in FIGS. 7(A) to 7(C). Alternatively or additionally, the blurring indicator generation module 192 may generate a blurring indicator at the time immediately after photography and may cause the display module 150 to display a message image according to the generated blurring indicator.

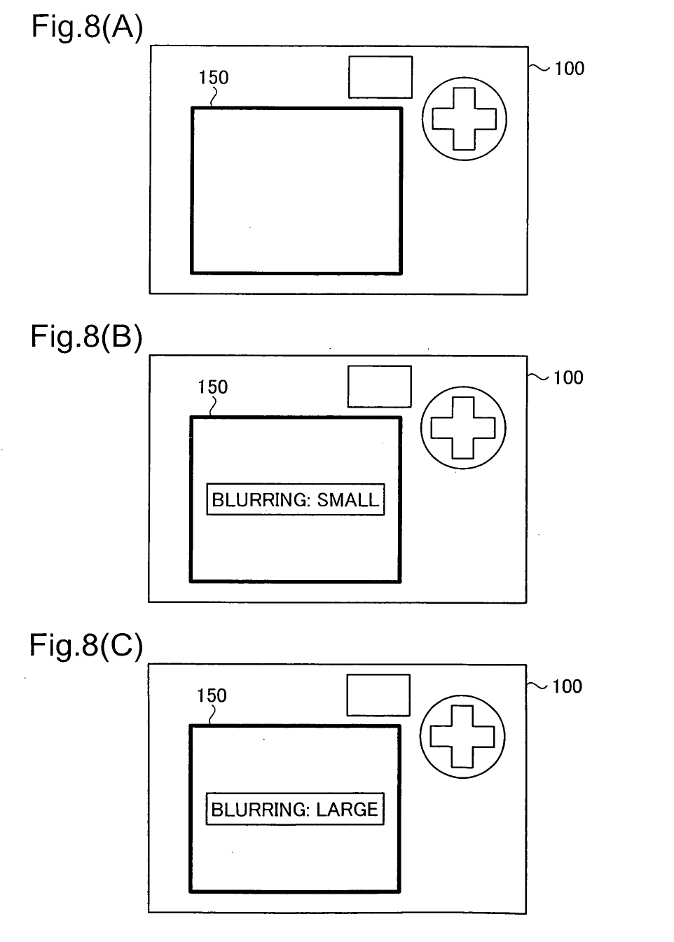

FIGS. 8(A) through 8(C) are schematics that show message images displayed on the display module 150 of the digital still camera 100 immediately after photography. FIGS. 8(A) through 8(C) correspond to FIGS. 7(A) through 7(C), respectively.

As shown, if the first blurring indicator is generated (FIG. 8(A)), the display module 150 displays no message image. On the other hand, if the second or third blurring indicator is generated (FIG. 8(B) or FIG. 8(C)), the display module 150 displays a message image. Specifically, if the second blurring indicator is generated (FIG. 8(B)), a message image of “BLURRING: SMALL” is displayed; whereas if the third blurring indicator is generated (FIG. 8(C)), a message image of “BLURRING: LARGE” is displayed.

By displaying the message images immediately after photography, the user can decide whether or not to photograph for another time immediately after the previous photography.

In FIG. 7(A) through 7(C) and FIGS. 8(A) through 8(C), an identifier is displayed on the display module 150 according to the corresponding type of blurring indicator, but instead of this, a notification according to the corresponding type of blurring indicator may be executed using a lamp or a speaker provided in the camera 100.

In general, the digital still camera should comprise a notification module for providing a notification to a user according to the blurring indicator. This allows the user to easily recognize a degree of blurring at the time of photography. It should be noted that in case where an identifier is displayed, as in this embodiment, there is an advantage that the user can easily recognize a degree of blurring in a visual way.

A2-3. Adjustment of Photography Condition with Use of Blurring Information in Digital Still Camera:

The digital still camera 100 of this embodiment can utilize blurring information that was acquired in the previous photography to automatically change the photography condition for the next photography.

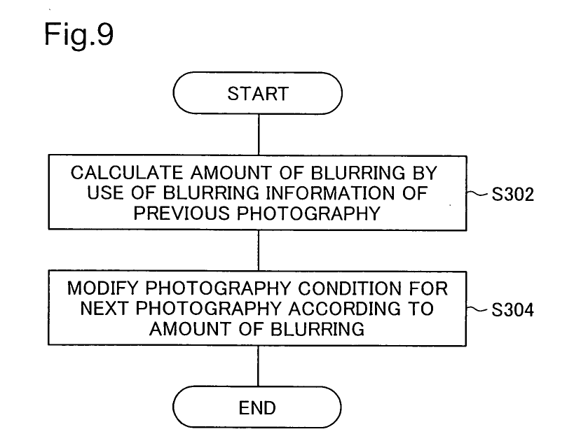

FIG. 9 is a flowchart that shows details of processing for modifying the photography condition for the next photography in the digital still camera 100.

In step S302, the control module 190 calculates an amount of blurring (angle of blurring) using the blurring information that was acquired in the previous photography. The angle of blurring is calculated by the blurring indicator generation module 192 by the use of the acceleration, the shutter speed, and the focal length, as described previously with reference to FIGS. 6(A) and 6(B).

In step S304, the photography condition is automatically changed for the next photography according to the calculated amount of blurring (angle of blurring). Specifically, if the calculated angle of blurring is relatively large, the control module 190 controls the photography control module 120 to increase the shutter speed for the next photography. In other words, the charge storage period of the imaging device 116 for the next photography is shortened. This reduces the shutter speed st in the equation (2), which in turn reduces the angles of blurring θdx, θdy in the equation (1). As a result, the generation of the blurring at the time image data is acquired in the next photography can be suppressed. The increase of shutter speed, however, leads to decrease of an amount of exposure. The control module 190 in this embodiment, accordingly, controls the signal conversion module 130 to increase a gain of analog image signals output from the imaging device 116 at the same time as increasing the shutter speed. This makes up for the decrease of the amount of exposure.

In this embodiment, the gain of analog image signals is increased at the same time as the shutter speed is increased, but instead of this or in addition to this, a degree of opening of the aperture may be increased. This also makes up for the decrease of the amount of exposure, which accompanies the increase of the shutter speed.

A3. Arrangement of Printer:

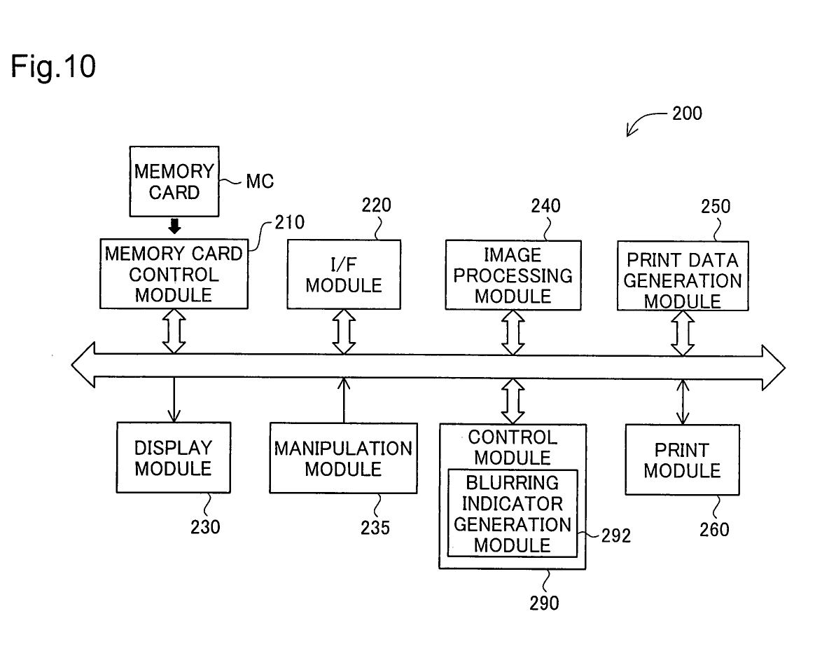

FIG. 10 is schematic that shows a general arrangement of the printer 200, for which an inkjet printer 200 is used in this embodiment. The printer 200 comprises a memory card control module 210, an interface module (I/F module) 220, a display module 230, a manipulation module 235, an image processing module 240, a print data generation module 250, a print module 260, and a control module 290 for controlling operations of the respective modules. It should be noted that, in this embodiment, functions of the image processing module 240, the print data generation module 250, and the control module are attained by computer programs.

The memory card control module 210 reads out an image file from a memory card MC that is attached to a memory card slot (not shown). The I/F module 220 receives via a cable an image file that was generated by the camera 100 and then reads out the received image file. The display module 230 displays image data included in the image file that was read out as above, and displays a menu image for makings various settings. The manipulation module 235 can execute various processing according to user instructions. For example, the user can cause the display module 230 to display the menu image by manipulating the manipulation module 235. The user can also set up the printing condition by manipulating the manipulation module 235.

The image processing module 240 extends the image data included in the image file and converts the YCbCr data into RGB data. The print data generation module 250 uses the RGB data so as to generate CMYK print data according to the printing condition that was set up as above. The print module 260 uses the print data so as to execute printing on a recording medium. The control module 290 analyzes additional information included in the image file and uses an image processing condition included in the additional information to cause the image processing module 240 to execute processing. Particularly in this embodiment, the control module 290 uses the blurring information included in the additional information so as to selectively prohibit the image processing module 240 from executing processing. Accordingly, the generation of print data by the print data generation module 250 and the printing of image by the print module 260 are executed selectively according to the blurring information.

The printer 200 functions as an image output device. The memory card control module 210, the I/F module 220, and the control module 290 are equivalent to a readout module; whereas the print data generation module 250 is equivalent to an output data generation module. Additionally, the image processing module 240 and the control module 290 are equivalent to a control module, and the print module 260 is equivalent to an output module. In particular, the memory card control module 210, the I/F module 220, image processing module 240, the print data generation module 250, and the control module 290 function as a control device for controlling the print module 260.

A3-1. Printing with Use of Blurring Information in Printer:

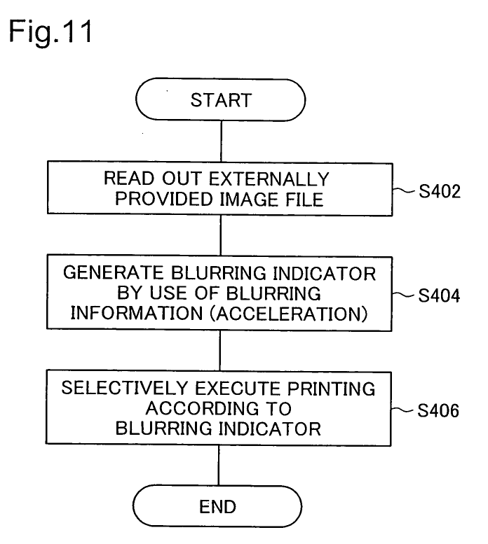

FIG. 11 is a flowchart that shows details of processing for printing an image in the printer 200.

In step S402, an externally provided image file is read out. Specifically, the memory card control module 210 reads out an image file that is included in a memory card attached to the printer. Alternatively, the I/F module 220 reads out an image file that was provided from the camera 100 via a cable.

In step S404, a blurring indicator is generated with use of blurring information included in the read out image file. Specifically, as in step S204 (FIG. 5), the control module 290 generates a blurring indicator by using an acceleration as blurring information, a shutter speed, and a focal length. It should be noted that the blurring indicator is generated by a blurring indicator generation module 292 (FIG. 10).

In step S406, printing is executed according to the blurring indicator generated in step S404. Specifically, if the first or second blurring indicator is generated by the blurring indicator generation module 292, the control module 290 permits the image processing module 240 to execute processing. This permits the print data generation module 250 to generate print data and thus as a result permits the print module 260 to print an image. If the third blurring indicator is generated by the blurring indicator generation module 292, the control module 290 prohibits the image processing module 240 from executing processing. This prohibits the print data generation module 250 from generating print data and thus as a result prohibits the print module 260 from printing an image.

In this way, whether or not print data is generated is determined according to the blurring indicator, and in case where a relatively large amount of blurring has occurred at the time the image data is acquired, there is no need to generate print data. This in turn eliminates the need to print an image and thus as a result eliminates the possibility of wasting resources such as printing media and inks. Furthermore, in case where a plurality of image files are provided, the printer 200 can execute printing selectively and successively according to each blurring indicator. This allows the printer 200 to print only the images with relatively high image qualities rapidly.

In this embodiment, the print data generation module 250 is prohibited from generating print data according to the blurring indicator. Instead of this, the print data generation module 250 may be permitted to generate print data and the print module 260 may be prohibited from executing printing based on the print data. In such a case, the control module 290 may control the print data generation module 250 according to the blurring indicator.

In this embodiment, printing is permitted in case where the second blurring indicator is generated, but instead of this, the printing may be prohibited in the same case. This choice can be made by a user through manipulation of the manipulation module 155.

A4. Modification of First Embodiment:

A4-1. First Modification:

In the first embodiment, the image file includes the acceleration information, and the camera 100 or the printer 200 generates the blurring indicator that indicates a degree of blurring by using the acceleration information. The image file, however, may alternatively include the blurring indicator itself. For such a case, the camera 100 may use the acceleration information so as to generate the blurring indicator and may generate an image file that includes the blurring information. This eliminates the need for the camera 100 or the printer 200 to generate the blurring indicator at every reproduction of image. The camera 100 or the printer 200, accordingly, can easily change the output of the image according to the blurring indicator.

A4-2. Second Modification:

In the first embodiment, the acceleration information is used for the generation of blurring indicator, but instead of this, the acceleration information may be used for the execution of image processing. For example, in case of “tracking shot” where a camera moves as its target object moves, the acceleration information at the time of photography may be used for the execution of effect processing or trimming processing of image data. Specifically, within the image data, images of the target object may be superimposed in a direction that is opposite to a traveling direction of the target object to express accelerative-ness of the target object (effect processing). Additionally, within the image data, more areas to the traveling direction of the target object may be extracted to obtain an appropriate pseudo-composition (trimming processing).

In general, an image generation device should acquire variation-related information that relates to a spatial variation of the image generation device, when the image data is acquired. An image output device should execute predetermined processing with respect to the output of image from an output module according to the variation-related information.

A4-3. Third Modification:

In the first embodiment, the printer 200 causes the print module 260 to execute printing according to the blurring information. The printer 200, however, may alternatively or additionally cause the display module 230 to execute displaying of image according to the blurring information. In such a case, the display module 230 of the printer 200 may display an identifier according to the blurring information or may prohibit the displaying of image according to the blurring information, similarly as the display module 150 of the digital still camera 100 does.

A4-4. Fourth Modification:

In the first embodiment, the printer 200 functions as an image output device and comprises a print module and a control device for controlling the print module. The function of the control device, however, may be incorporated in the digital still camera 100. In other words, the camera may also function as the control device for controlling the print module as an output module. Specifically, the image processing module 240 and the print data generation module 250 of the printer 200 may be provided in the camera. In this way, the camera can control the printing by the printer by connecting to the printer directly via a cable. In such a case, the print data generated by the camera is transmitted to the printer.

Similarly, a personal computer may function as the control device for controlling the print module as an output device.

A4-5 Fifth Modification:

In the first embodiment, either the display module 150 provided in the digital still camera 100 or the print module 260 provided in the printer 200 functions as an output module. Other display devices, however, such as a monitor or a projector connected to the personal computer may alternatively function as the output module.

A4-6: Sixth Modification:

Although an image file of Exif format is generated in the first embodiment, an image file of other format may alternatively be generated. Additionally, although the image data and the additional information are included within one image file in the first embodiment, the image data and the additional information may alternatively be stored separately. Even in such a case, correspondence data, which indicates a correspondence of the image data to the additional information, may be generated in order to associate the image data with the additional information.

B. Second Embodiment:

B1. Arrangement of Image Processing System:

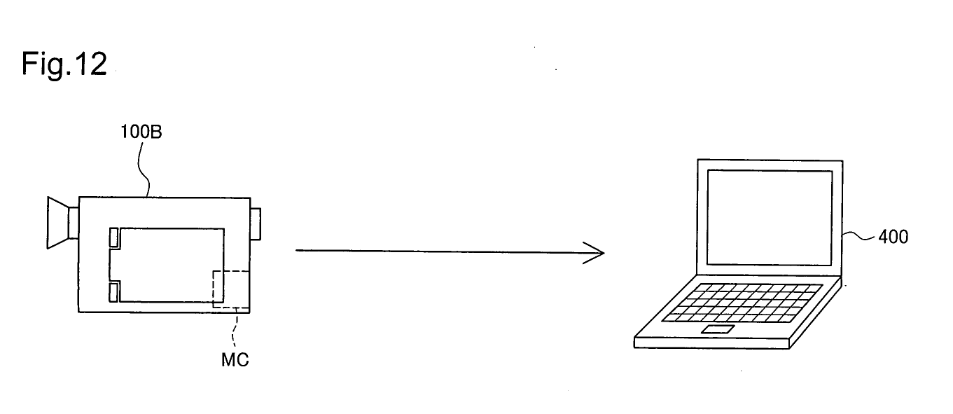

FIG. 12 is a schematic that shows an image processing system of a second embodiment. The image processing system comprises a digital video camera 100B and a personal computer 400. The camera 100B photographs a target object and generates dynamic image data. An image represented by the dynamic image data is displayed on a display module provided in the camera 100B or a display module provided in the personal computer 400. The image data is supplied from the camera 100B to the personal computer 400 via a memory card MC or via a cable. It should be noted that a digital video tape or a DVD may be used instead of the memory card MC.

B2. Arrangement of Digital Video Camera:

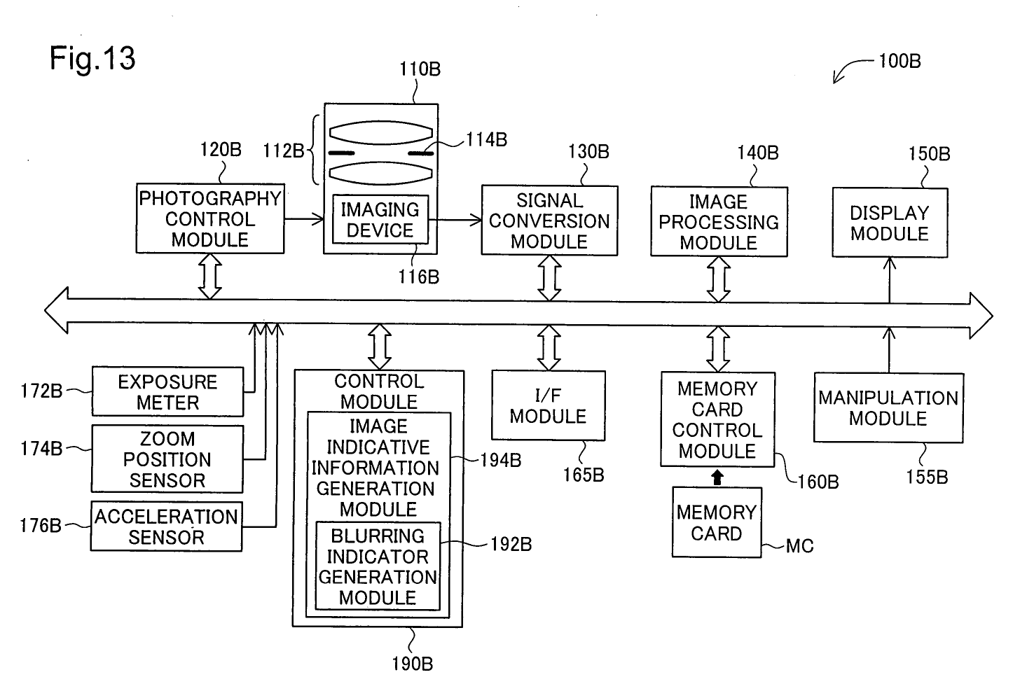

FIG. 13 is a schematic that shows a general arrangement of the digital video camera 100B. Each component shown in FIG. 13 is similar to the corresponding component shown in FIG. 2 and is represented by the same reference number with “B” attached to the end, except that a control module 190B is changed. The control module 190B comprises an image indicative information generation module 194B that includes a blurring indicator generation module 192B. It should be noted that the camera 100B of this embodiment can acquire dynamic image data in addition to static image data that can also be acquired by the camera 100 of the first embodiment.

The control module 190B controls a memory card control module 160B to store the dynamic image data into the memory card MC. At this time, additional information, which will be described later, is associated with the dynamic image data and is also stored in the memory card MC. In this embodiment, the dynamic image data and the additional information are included in separate files.

The blurring indicator generation module 192B generates three types of blurring indicators as in the first embodiment. However, in this embodiment, the blurring indicator generation module 192B sequentially generates a blurring indicator, i.e. generates a blurring indicator each time an image that constitutes the dynamic image is acquired. The image indicative information generation module 194B uses the blurring indicator acquired for each image and generates image indicative information. The image indicative information includes information that indicates a group of continuous image data corresponding to a specific type of blurring indicator. In this embodiment, the additional information that contains the image indicative information is stored in the memory card MC.

Examples of the additional information include photography information at the time the dynamic image data is acquired, a thumbnail image, and the like. Examples of the photography information include datetime of photography, a scene of photography, and the like.

B2-1. Generation of Image Indicative Information in Digital Video Camera:

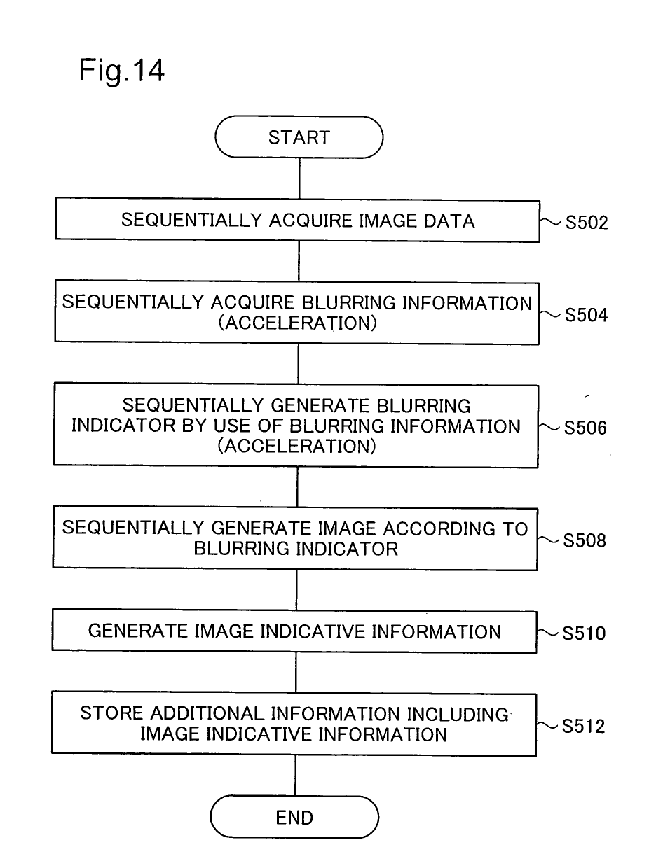

FIG. 14 is a flowchart that shows details of processing for generating image indicative information in the digital video camera 100B and corresponds to FIG. 4.

In step S502, image data is acquired sequentially through photography, as in the first embodiment (FIG. 4).

In step S504, a blurring information (acceleration) is acquired sequentially, as in the first embodiment (FIG. 4). In step S504, a shutter speed (charge storage period) and a focal length are also acquired along with the acceleration. The blurring information (acceleration), shutter speed, and focal length are acquired each time the image data is acquired.

In step S506, the blurring indicator generation module 192B uses the acceleration as the blurring information, the shutter speed, and the focal length so as to generate a blurring indicator that indicates a degree of blurring.

The blurring indicator is generated similarly as in the first embodiment. However, in this embodiment, if a condition of “θdx=0 and θdy=0” is satisfied, the first blurring indicator is generated to indicate that no blurring has occurred at the time of photography, that is to say, no blurring exists within the image. If a condition of “0<θdx<θp and 0<θdy<θp” is satisfied, the second blurring indicator is generated to indicate that a relatively small amount of blurring has occurred at the time of photography, that is to say, a relatively small amount of blurring exists within the image. If a condition of “θdx >=θp or θdy >=θp (that is, θdx or θdy is not less than θp)” is satisfied, the third blurring indicator is generated to indicate that a relatively large amount of blurring has occurred at the time of photography, that is to say, a relatively large amount of blurring exists within the image.

In step S508, an image is sequentially displayed according to the blurring indicator. Specifically, the control module 190B controls an image processing module 140B and causes a display module 150B to display the image that is sequentially photographed as well as a mark image that is indicative of the blurring indicator.

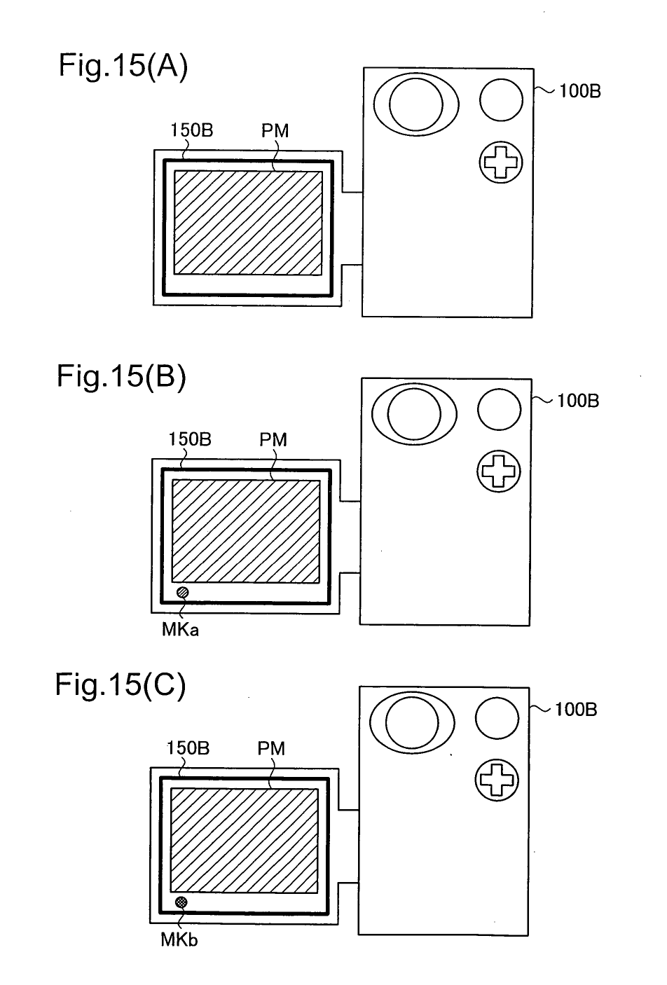

FIGS. 15(A) through 15(C) are schematics of images displayed on the display module 150B of the digital video camera 100B. FIG. 15(A) shows an image that is to be displayed if the first blurring indicator is generated. In FIG. 15(A), the display module 150B displays a photographed image PM with no mark image therewith. FIG. 15(B) shows an image that is to be displayed if the second blurring indicator is generated. In FIG. 15(B), a yellow mark image MKa is displayed at the lower left of a photographed image PM. FIG. 15(C) shows an image that is to be displayed if the third blurring indicator is generated. In FIG. 15(C), a red mark image MKb is displayed.

By switching between display and not-display of mark image and changing color of mark image to be displayed according to the blurring indicator as described above, the user can make various countermeasures. For example, if it is determined that a large amount of blurring has occurred at the time of photography, the user can correct the way to hold the camera 100B or take another photograph again. In this embodiment, no mark image is displayed if the first blurring indicator is generated, but instead of this, a blue mark image, for example, may be displayed.

In step S510 (FIG. 14), the image indicative information generation module 194B uses the blurring indicator, which has been sequentially generated for each image, so as to generate image indicative information.

In step S512, the control module 190B associates the additional information, which contains the image indicative information generated in the step S510, with the dynamic image data acquired in the step S502, and stores them in the memory card MC. The association of the dynamic image data and the additional information can be established by setting a filename of the additional information to a photography datetime of the dynamic image, or alternatively by setting the dynamic image data and the additional information to have the same filenames except for extensions.

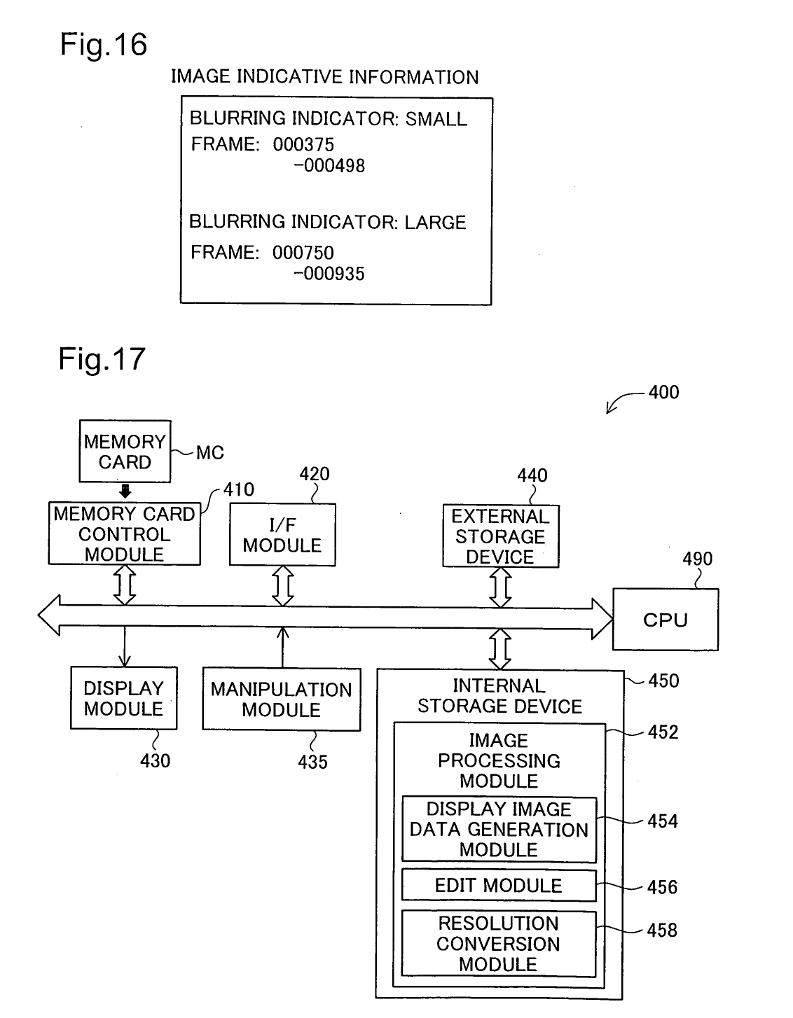

FIG. 16 is a schematic that shows details of the image indicative information. As shown in FIG. 16, the image indicative information contains two informative elements. Each of the informative elements contains blurring indicator information that is indicative of a blurring indicator and frame number information that is indicative of a group of continuous images corresponding to the blurring indicator. The image indicative information shown in FIG. 16 contains frame number information “000375-000498” corresponding to a blurring indicator “small” and frame number information “000750-000935” corresponding to a blurring indicator “large”. The frame number information contains the number of a frame that is to be reproduced at the earliest and the number of a frame that is to be reproduced at the last from among a plurality of frames that constitute the group of images. As can be appreciated from the foregoing, the frame number information “000375-000498” corresponding to the blurring indicator of “small”, for example, represents that the second blurring indicator “small” is acquired at the time the group of images of the numbers “000375” to “000498” are photographed.

Although the image indicative information shown in FIG. 16 contains frame number information that correspond to two types of blurring indicators “small” and “large”, the image indicative information may additionally contain another frame number information that corresponds to a blurring indicator “none”.

Once the dynamic image data and the additional information are associated with one another and stored, the image indicative information included in the additional information can be utilized, after the photography, for various processing carried out external to the digital video camera. That is to say, the dynamic image data and the additional information are stored in a way available to external devices after the photography.

B3. Arrangement of Computer:

FIG. 17 is a schematic that shows a general arrangement of the personal computer 400. The computer 400 comprises a memory card control module 410, an interface module (I/F module) 420, a display module 430, a manipulation module 435, an external storage device 440, an internal storage device 450 such as ROM or RAM, and a CPU 490.

The internal storage device 450 has a program stored therein that functions as an image processing module 452. The image processing module 452 includes a display image data generation module 454 and causes the display module 430 to display dynamic image data. The image processing module 452 also includes an editing module 456 and a resolution conversion module 458, which are used for processing dynamic image data. The functions of the image processing module 452 are attained through execution of programs by the CPU 490.

The computer 400 functions as an image output device. The memory card control module 410, the I/F module 420, and the CPU 490 are equivalent to readout module of the image output device of the present invention. The image processing module 452 and the CPU 490 are equivalent to a control module. The display module 430 is equivalent to an output module. In particular, the memory card control module 410, the I/F module 420, the image processing module 452, and the CPU 490 function as a control device for controlling the display module 430.

B3-1. Display of Image with Use of Image Indicative Information in Computer:

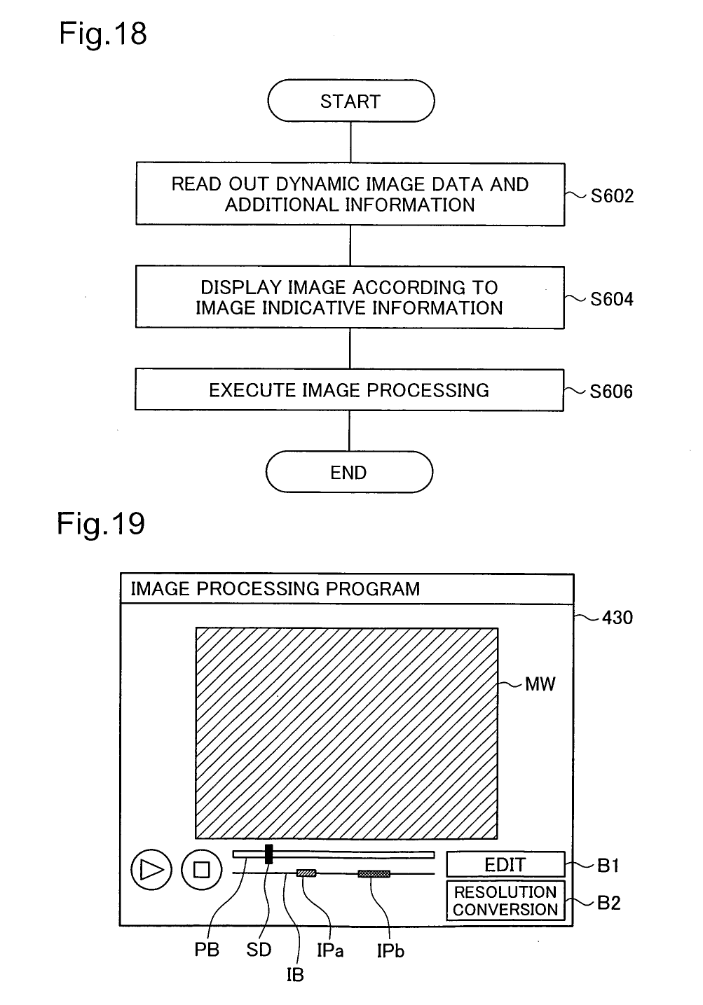

FIG. 18 is a flowchart that shows details of processing for displaying a dynamic image in the computer 400.

In step S602, dynamic image data and its associated additional information are read out. For example, the CPU 490 may control the memory card control module 410 to read out dynamic image data and additional information that are included in a memory card MC. In addition, the CPU 490 may control the I/F module 420 to read out dynamic image data and additional information that are given from the camera 100B via a cable. Furthermore, the CPU 490 may read out dynamic image data and additional information that are previously stored in the external storage device 440. It should be noted that, previous to the readout of dynamic image data, a user may select desired dynamic image data from among a list of dynamic image data (for example, thumbnail image) that is displayed on the display module 430 of the computer 400.

In step S604, an image is displayed according to image indicative information that is included in the additional information. Specifically, the display image data generation module 454 uses the dynamic image data and image indicative information so as to generate display image data and supplies the display image data to the display module 430. The image represented by the display image data includes a dynamic image represented by the dynamic image data and an indicative image generated with use of the image indicative information.

FIG. 19 is a schematic that shows an image displayed on the display module 430. As shown, a window of image processing program (image processing module) is displayed on the display module 430. A display area MW for displaying a dynamic image is provided within the window. A positional bar PB is provided on the lower side of the display area MW and a slider SD is provided on the positional bar PB. The positional bar PB represents an entire reproduction period of dynamic image data and the slider SD represents a current reproduction position within the entire reproduction period.

A blurring indicator bar IB is provided on the lower side of the positional bar PB. The blurring indicator bar IB has the same length as the positional bar PB and represents an entire reproduction period of dynamic image data in a way similar to the positional bar PB. A yellow-colored first indicative image IPa that indicates a blurring indicator “small” and a red-colored second indicative image IPb that indicates a blurring indicator “large” are superimposed on the blurring indicator bar IB. The lengths (that is, display ranges) of the first and second indicative images IPa and IPb are determined by using the image indicative information, respectively. For example, the display range of the first indicative image IPa is determined by the use of the frame number information “000375-000498”, which corresponds to the blurring indicator “small”, as shown in FIG. 16. Namely the first indicative image IPa represents a reproduction period of a group of images corresponding to the blurring indicator “small”; whereas the second indicative image IPb represents a reproduction period of a group of images corresponding to the blurring indicator “large”. Each range with no indicative image represents a reproduction period of a group of images corresponding to a blurring indicator “none”.

As shown in FIG. 19, since the display image data generation module 454 displays an indicative image according to the image indicative information, the user can easily confirm presence or absence of blurring or a degree of blurring included in the dynamic image. The user can also easily confirm a reproduction period of a group of images corresponding to a specific blurring indicator, from among the entire reproduction period of the dynamic image.

In step S606 (FIG. 18), various image processing are executed. Specifically, when an edit button B1 is selected by the user in the window shown in FIG. 19, the edit module 456 executes edit processing. When a resolution conversion button B2 is selected by the user, on the other hand, the resolution conversion module 458 executes resolution conversion processing.

In the edit processing, the user can edit the dynamic image while confirming the indicative images IPa, IPb. For example, the user can delete the group of image data that are included within the display range of the second indicative image IPb, which indicates the blurring indicator “large”, from among the dynamic image data.

In the resolution conversion processing, the user can select a target image from among the dynamic images while confirming the indicative image, and thereby execute resolution conversion processing of the target image. In this embodiment, the resolution conversion processing of the target image is executed by the use of the target image and a reference image. As for the reference image, an image that is to be reproduced in succession to the target image is selected. Specifically, the resolution conversion module 458 aligns the target image with the reference image and when the alignment is complete, synthesizes the target image and the reference image. This results in generation of a fine static image with a relatively high resolution (processed target image). It should be noted that the alignment of the two images can be executed by the use of a pattern matching method, which is a combination of parallel translation and rotation.

In the resolution conversion processing, values of respective pixels that constitute the processed target image can be generated by the use of the aligned target image and reference image. Specifically, values of respective pixels in the processed target image can be generated by an interpolation that uses values of a plurality of corresponding pixels included in the target image or values of a plurality of corresponding pixels included in the reference image. It is therefore preferable that a small amount of deviation exists between the target image and the reference image.

If no deviation exists between the target image and the reference image (i.e. if the two images are identical), no fine processed target image can be obtained even if the reference image is used. Additionally, if a large amount of deviation exists between the target image and the reference image, it may be difficult to find a corresponding pixel from within the reference image for each pixel that constitutes the processed target image. On the other hand, if a small amount of deviation exists between the target image and the reference image, it may be easy to find a corresponding pixel from within the reference image and a fine processed target image may be generated through the resolution conversion processing that uses the reference image.

As for the group of images corresponding to the first indicative image IPa that is indicative of a blurring indicator “small”, a small amount of deviation exists between two successive images. Accordingly, the user can obtain a fine processed target image by selecting a target image from within the group of images corresponding to the first indicative image IPa. It should be noted that the resolution conversion button B2 is preferably set active (selectable) only if the slider SD overlaps the display range of the indicative image IPa. The processed target image can be printed out by the printer to result in a fine printed image.

B4. Modifications of Second Embodiment:

B4-1. First Modification:

In the second embodiment, the image indicative information contains two pieces of frame number information that correspond to blurring indicators “small” and “large”, respectively. The image indicative information, however, may only contain one piece of frame number information that corresponds to a blurring indicator “small”, which is suitable for the resolution conversion processing. If the image indicative information only contains one piece of frame number information that corresponds to one type of blurring information, the blurring indicator information for distinguishing between plural types of blurring indicators, as shown in FIG. 16, can be omitted.

Although the image indicative information contains frame number information in the second embodiment, the image indicative information may alternatively contain reproduction time information. The reproduction time information contains a reproduction time of a frame that is to be reproduced at the earliest and a reproduction time of a frame that is to be reproduced at the last, from among a plurality of frames that constitute a group of images.

In general, the image indicative information should contain information that indicates a group of images corresponding to a specific blurring indicator.

B4-2. Second Modification:

Although the blurring indicator generation module 192B is provided in the second embodiment, it can be omitted. In such a case, the image indicative information generation module 194B generates image indicative information by using the acceleration that is acquired for each image. Specifically, the image indicative information generation module 194B selects a group of images whose accelerations satisfy a predetermined condition and generates image indicative information that indicates the group of images. In this way, the same image indicative information can be acquired as in the case of using blurring indicators. This is because if accelerations of a group of images satisfy a predetermined condition, the blurring indicator that corresponds to the group of images indicates a same degree of variation.

B4-3. Third Modification:

In the second embodiment, the image indicative information contains informative elements, each indicating a group of continuous images that corresponds to a specific type of blurring indicator. The image indicative information, however, may alternatively contain informative elements, each indicating every one of a plurality of images that correspond to the specific type of blurring indicator. The case where the image indicative information contains informative elements that indicate groups of continuous images, however, is advantageous in that the additional information including the image indicative information can have a relatively reduced data size.

B4-4. Fourth Modification:

In the second embodiment, the dynamic image data is associated with the additional information that contains image indicative information. The dynamic image data, however, may alternatively be associated with additional information that contains physical information corresponding to each individual piece of image data that constitutes the dynamic image data, or additional information that contains a blurring indicator corresponding to each individual piece of image data that constitutes the dynamic image data.

B4-5. Fifth Modification:

In the second embodiment, the acceleration is acquired for every image that constitutes the dynamic image, but instead of this, the acceleration may be acquired for every plural (e.g. two) images that constitute the dynamic image.

The present invention is not limited to the embodiments and the modifications described above, but may be implemented in various aspects without departing from the spirit of the present invention. For example, the following modifications are possible.

(1) Although three types of blurring indicators are generated in the above embodiments, four or more types of blurring indicators or two types of blurring indicators may alternatively be generated. In case where two types of blurring indicators are generated, the blurring indicators may preferably indicate presence and absence of blurring, respectively.

(2) Although acceleration, shutter speed, and focal length are used for the generation of blurring indicator in the above embodiments, only acceleration and shutter speed may alternatively be used for the generation of blurring indicator. In such a case, the blurring indicator can be generated by the use of displacements dx, dy in x-direction and y-direction as amounts of blurring and on the basis of a relationship between the displacements dx, dy in the x-, y-directions and a pixel-to-pixel pitch p. Further alternatively, only acceleration may be used for the generation of blurring indicator. In such a case, the blurring indicator may be generated according to a relationship between the detected acceleration and a predetermined reference value. However, if acceleration, shutter speed, and focal length are used as in the above embodiments, blurring indicator that indicates a degree of blurring with high precision can be generated.

Although acceleration is used for the generation of blurring indicator in the above embodiments, angular velocity may alternatively be used for the same purpose. In this case, the camera 100 or 100B will be equipped with an angular velocity sensor (e.g. gyro sensor). Blurring indicator may be generated by the use of the following equation (3) instead of the equation (1). It should be noted that values wx, wy (rad/sec) in the equation (3) represent angular velocities of the camera in the x-direction and the y-direction, respectively.
θdx=wx*st
θdy=wy*st (3)

In general, at the time the image data is acquired, physical information that represents a spatial variation of the image generation device, such as acceleration information or angular velocity information, should be acquired. Then, the burring information should be generated by using at least the physical information.

(3) Although the image data and the additional information are included in one image file in the first embodiment, the image data and the additional information may alternatively be included in separate files. In such a case, every one piece of image data may have one additional information file associated therewith or every plurality pieces of image data may have one additional information file associated therewith.

Although the dynamic image data and the additional information are included in separate files in the second embodiment, the dynamic image data and the additional information may alternatively be included in one dynamic image file.

In general, the image data should be associated with additional information including the variation information (i.e. variation-related information).

1. An image data generation method for generating image data in an image generation device that is capable of photographing a target object, the method comprising the steps of:
(a) acquiring the image data by photographing the target object;
(b) acquiring variation-related information, wherein the variation-related information relates to a spatial variation of the image generation device at the time the image data is acquired; and
(c) associating and storing the acquired image data and the acquired variation-related information with one another.

2. The image data generation method according to claim 1, wherein the step (b) includes the step of:
(b1) detecting physical information, wherein the physical information represents the spatial variation of the image generation device at the time the image data is acquired, and wherein
the variation-related information includes the physical information.

3. The image data generation method according to claim 2, further comprising the steps of:
(d) generating a variation level indicator by using the physical information, the variation level indicator indicating a degree of variation of the image generation device; and
(e) providing a notification to a user according to the variation level indicator.

4. The image data generation method according to claim 1, wherein the step (b) includes the steps of:
(b2) detecting physical information, wherein the physical information represents the spatial variation of the image generation device at the time the image data is acquired; and
(b3) generating a variation level indicator by using the physical information, the variation level indicator indicating a degree of variation of the image generation device, and wherein
the variation-related information includes the variation level indicator.

5. The image data generation method according to claim 4, further comprising the step of:
(f) providing a notification to a user according to the variation level indicator.

6. The image data generation method according to claim 3, wherein the physical information is acceleration information, and
the step (d) includes the step of generating the variation level indicator by further using shutter speed information that is of the time the image data is acquired.

7. The image data generation method according to claim 6, wherein the step (d) includes the step of generating the variation level indicator by further using focal length information that is of the time the image data is acquired.

8. The image data generation method according to claim 3, wherein the physical information is angular velocity information, and
the step (d) includes the step of generating the variation level indicator by further using shutter speed information that is of the time the image data is acquired.

9. The image data generation method according to claim 3, wherein the image generation device comprises a display module for displaying an image represented by the image data, and
the step (e) includes the step of providing the notification by displaying an identifier on the display module according to the variation level indicator.

10. The image data generation method according to claim 1, further comprising the step of:
(g) modifying shutter speed for the next photography in the step (a) according to the previous variation-related information acquired in the step (b).

11. The image data generation method according to claim 1, wherein the image data is dynamic image data that include a plurality of individual image data.

12. The image data generation method according to claim 11, wherein the step (b) includes the steps of:
(b4) sequentially detecting physical information at the time the dynamic image data is acquired, the physical information represents the spatial variation of the image generation device; and
(b5) generating image indicative information by using the sequentially detected physical information, where the image indicative information indicates a group of individual image data included in the dynamic image data and the physical information corresponding to the group of individual image data satisfies a predetermined condition,
and wherein the variation-related information includes the image indicative information.

13. The image data generation method according to claim 12, wherein the step (b5) includes the steps of:
sequentially generating a variation level indicator by using the sequentially detected physical information, where the variation level indicator indicates a degree of variation of the image generation device; and
generating image indicative information by using the sequentially generated variation level indicator.

14. An image generation device comprising:
an image data acquisition module for acquiring image data by photographing a target object;
a variation-related information acquisition module for acquiring variation-related information, wherein the variation-related information relates to a spatial variation of the image generation device at the time the image data is acquired; and
a storage execution module for associating and storing the acquired image data and the acquired variation-related information with one another.

15. A control method for controlling an output module that outputs a target image represented by image data, by using the image data acquired by an image generation module and additional information associated with the image data, the method comprising the steps of:
(a) reading out the image data and the additional information;
(b) generating output data by using the image data, where the output data is to be supplied to the output module and represents the target image; and
(c) executing a predetermined control with respect to output of the target image from the output module, according to variation-related information that is included in the additional information and relates to a spatial variation of the image generation module at the time the image data is acquired.

16. The control method according to claim 15, wherein the variation-related information includes physical information that represents the spatial variation of the image generation module at the time the image data is acquired, and
the step (c) includes the steps of:
(c1) generating a variation level indicator by using the physical information, where the variation level indicator indicates a degree of variation of the image generation module; and
(c2) executing the predetermined control by using the variation level indicator.

17. The control method according to claim 16, wherein the physical information is acceleration information, and
the step (c1) includes the step of generating the variation level indicator by further using shutter speed information that is of the time the image data is acquired.

18. The control method according to claim 17, wherein the step (c1) includes the step of generating the variation level indicator by further using focal length information that is of the time the image data is acquired.

19. The control method according to claim 15, wherein the variation-related information includes a variation level indicator that indicates a degree of variation of the image generation module at the time the image data is acquired, and
the step (c) includes the step of executing the predetermined control by using the variation level indicator.

20. The control method according to claim 15, wherein the step (c) includes the step of prohibiting output of the target image from the output module, according to the variation-related information.

21. The control method according to claim 20, wherein the output module is a print module,
the step (b) includes the step of generating print data by using the image data, where the print data is to be supplied to the print module, and
the step (c) includes the step of prohibiting generation of the print data in the step (b), according to the variation-related information.

22. The control method according to claim 15, wherein the output module is a display module,
the step (b) includes the step of generating display data by using the image data, where the display data is to be supplied to the display module, and
the step (c) includes the step of causing generation of the display data in the step (b), such that an identifier is displayed in the display module according to the variation-related information.

23. The control method according to claim 15, wherein the image data is dynamic image data that includes a plurality of individual image data.

24. The control method according to claim 23, wherein the variation-related information includes image indicative information that indicates a group of individual image data included in the dynamic image data, where physical information that represents the spatial variation of the image generation module at the time the group of individual image data are acquired by the image generation module, satisfies a predetermined condition,
the output module is a display module,
the step (b) includes the step of generating display data by using the dynamic image data, where the display data is to be supplied to the display module; and
the step (c) includes the step of causing generation of the display data in the step (b), such that a first image and a second image are displayed in the display module, the first image indicating a reproduction period in which the dynamic image data is reproduced and the second image indicating a reproduction period in which the group of individual image data is reproduced according to the image indicative information.

25. A control device for controlling an output module that outputs a target image represented by image data, by using the image data acquired by an image generation module and additional information associated with the image data, the device comprising:
a readout module that reads out the image data and the additional information;
an output data generation module that generates output data by using the image data, where the output data is to be supplied to the output module and represents the target image; and
a control module that executes a predetermined control with respect to output of the target image from the output module, according to variation-related information that is included in the additional information and relates to a spatial variation of the image generation module at the time the image data is acquired.

26. An image output device comprising:
the control device according to claim 25; and
the output module.

27. A computer program product for controlling an output module that outputs a target image represented by image data, by using the image data acquired by an image generation module and additional information associated with the image data, the product comprising:
a computer-readable recording medium; and
a computer program that is recorded in the recording medium,
the computer program includes:
a first program for reading out the image data and the additional information;
a second program for generating output data by using the image data, where the output data is to be supplied to the output module and represents the target image; and
a third program for executing a predetermined control with respect to output of the target image from the output module, according to variation-related information that is included in the additional information and relates to a spatial variation of the image generation module at the time the image data is acquired.
